(19) United States
(12) Patent Application Publication
(10) Pub. No.: US 2009/0103785 A1
(43) Pub. Date: Apr. 23, 2009

(54) OCULAR IDENTIFICATION SYSTEM FOR USE WITH A MEDICAL DEVICE

(75) Inventor: Joseph E. Pedroza, Vista, CA (US)

Correspondence Address: ADVANCED MEDICAL OPTICS, INC., 1700 E. ST. ANDREW PLACE, SANTA ANA, CA, 92705, US

(73) Assignee: Advanced Medical Optics, Inc., Santa Ana, CA (US)

(21) Appl. No.: 11/874,665

(22) Filed: Oct. 18, 2007

(51) Int. Cl. G06K 9/00

(52) U.S. Cl. 382/117

(57) ABSTRACT

A method and system for authenticating a user of a medical device is provided. Ocular signatures are stored in a database for at least one permitted user. Stored ocular signatures are compared to an individual ocular signature. The user can employ selected functionality of the medical device when at least one stored ocular signature substantially matches the individual ocular signature. The device may include a medical component and a computing device. The computing device includes a database configured to receive and maintain permitted user ocular signatures and a computational utility configured to compare the ocular signature of the user to at least one permitted user ocular signature maintained in the database. Upon determining that the ocular signature of the user substantially matches at least one permitted user ocular signature, the user is authorized to employ selected functionality of the medical device.

### BACKGROUND OF THE INVENTION

1. Field of the Invention

The present invention relates generally to the art of medical instrument systems, and more specifically to an authentication and authorization utility for use in operating a medical device or instrument.

2. Description of the Related Art

Today's medical instrument systems, such as medical products or surgical equipment, typically are deployed in operating theater environments shared by multiple users, such as surgeons or other medical personnel. In these environments, a surgeon can select and recall a program from a group of programs, and can alter existing settings to change the stored configuration parameter values. Setting the configuration parameter values allows the surgeon to tailor the behavior of the instrument system for an upcoming medical procedure. Today's medical instrument system programs can provide a wide flexible range of use and typically allow individual users to maintain complex collections of settings, or values, for various configurable parameters called with a specific program for use by a surgeon to instruct control of the machine.

In operating theater environments, a precision surgical device, such as a phacoemulsification machine, typically operates or behaves based pursuant to the contents of a program contained therein. A surgeon may load a program into the medical instrument system to set the values for the prescribed procedure. Programs typically involve setting of specific instrument configuration parameters that tailor the behavior of the surgical instrument while performing a specific medical procedure or for a particular situation.

Current medical instrument system designs are commonly found and utilized in a group practice or hospital environment where multiple surgeons share, i.e. individually operate, a single system. For example, today's machines afford the surgeon ability to individually set vacuum, flow, ultrasound intensity and duration, pulse shape, and other system parameters and save these settings within a program stored in their profile. These systems must save each individual surgeon's specific configuration parameter settings, i.e. user profile, and must be able to recall these settings when selected by a surgeon preparing to utilize the medical instrument system.

Today's medical instrument system designs typically involve a basic access control mechanism for users to select their stored profile and access subsequent programs, i.e. preferences and settings. The basic access control mechanism may involve the user navigating a series of menu's, for example displayed via a graphical user interface (GUI), and may input their selection, e.g. a surgeon's name, procedure type, or other attribute by pressing buttons presented on the menu via a touch-sensitive monitor and accessing their programs.

A major commercial problem with regard to current designs is that such designs rely on a manual selection procedure to input user information into the system sufficient to access their own profile and stored programs therein. The manual selection procedure may require users to traverse a large number of screen menus, each menu presenting multiple selections, i.e. “buttons”, to obtain and load their profile into the medical instrument system. The number of menu's and selection buttons generally increase proportional to the number of users, i.e. profiles, and procedure types, i.e. programs, supported. This total number of menu's and selections presented can become cumbersome to the user by requiring additional time to navigate the screen menus required to support a large number of profiles and may become increasingly prone to selection input error. Such designs can require intensive labor to set up the medical instrument properly, particularly where different surgeons employ different programs and parameters for use on a single machine.

In the situation where another surgeon needs to take-over and complete the procedure, the first surgeon conducting the procedure must stop and allow the second surgeon to input her user information into the system such that she may gain access to the medical instrument system and control the behavior based on programs stored within her own profile. The surgical procedure may become interrupted during the time required for the second surgeon to interact with the system and successfully transfer control.

Thus, today's medical instrument system designers are faced with a difficult and complex implementation challenge to insure a surgeon can easily, rapidly, accurately, and reliably identify themselves to the medical instrument system affording access to their profile and authorization to load and execute, or put-into-use, programs representing the surgeons desired surgical instrument configuration parameters to provide control and feedback of the medical instrument.

Based on the foregoing, it would be advantageous to provide an authentication and authorization utility for use in medical instrument systems that overcomes the foregoing drawbacks present in previously known designs used in the control and operation of surgical instruments.

### SUMMARY OF THE INVENTION

According to a first aspect of the present design, there is provided a method for authenticating a user of a medical device. The method comprises storing ocular signatures in a database for at least one user permitted to access the medical device, comparing the stored ocular signatures to an individual ocular signature associated with an individual desiring to employ the medical device, and enabling the user to employ selected functionality of the medical device when at least one stored ocular signature substantially matches the individual ocular signature.

According to a second aspect of the present design, there is provided a medical system comprising a medical component and a computing device associated with the medical component. The computing device comprises a database configured to receive and maintain at least one permitted user ocular signature and a computational utility configured to receive an ocular signature of a user and compare the ocular signature of the user to at least one permitted user ocular signature maintained in the database. Upon the computational utility determining that the ocular signature of the user substantially matches at least one permitted user ocular signature, the user is authorized to employ selected functionality of the medical device.

These and other advantages of the present invention will become apparent to those skilled in the art from the following detailed description of the invention and the accompanying drawings.

### BRIEF DESCRIPTION OF THE DRAWINGS

The present invention is illustrated by way of example, and not by way of limitation, in the figures of the accompanying drawings in which:

FIG. 1A is a functional block diagram of a phacoemulsification system that may be employed in accordance with an aspect of the present invention;

FIG. 1B illustrates a layout for storing data and programs in the multiple-level database structure in accordance with an aspect the present design;

FIG. 2 is a block diagram illustrating the ocular identification apparatus and method in accordance with an aspect of the present invention; and

FIG. 3 is a flow chart illustrating an authentication and authorization utility for accessing programs stored within a medical instrument system in accordance with an aspect of the present invention.

### DETAILED DESCRIPTION OF THE INVENTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

The present design is directed to quickly accessing relatively large complex collections of system configuration parameter settings organized according to individual users of a safety critical system such as a medical instrument system. The present design provides an apparatus and method for authenticating a user's identity and providing authorization to load and execute a program from the identified user's profile.

In short, the present design apparatus and method may be used to precisely authenticate the user's identity and rapidly configure a medical instrument system according to a program stored within their profile over its entire operational range for a given procedure or set of procedures indicated for a particular patient case or condition. The apparatus and method may provide a quick, easy to use, accurate, and reliable mechanism for recalling any individual program based on the user's identity and flexible enough to allow seamless transition from one surgeon to the next without manually entering information relating to profile access.

### Biometric Technology

Biometric technologies are available for accurately and reliably authenticating a user's identity. Biometric technologies include fingerprint, ocular, face, speech, and writing recognition. However, in a sterile environment such as an operating theater, many of these technologies may not function properly or be too cumbersome and not alleviate the problem associated with time required to authenticate a user and manually enable settings or select a program. For example, fingerprint recognition technology will not function properly as the users wear sterile gloves. Similarly, face recognition technology is difficult to implement as the user wears a cap and/or facemask. Speech recognition may be difficult to implement due to various sounds, e.g. other medical personnel talking, and noise, e.g. generated by medical equipment, generally found in an operating theater.

Ocular biometric technologies include retinal scans and iris recognition. Both of these technologies are suitable for use with the present design to authenticate a user's identity. Retinal scans of the eye may provide the most accurate and reliable biometric technology. Iris recognition is available for use in an operating theater environment to identify a surgeon to operate a medical instrument system. Iris recognition is considered by many to be less intrusive than retinal scans, more stable, and can provide an unambiguous positive identification of an individual or user.

### System Example

While the present design may be used in various environments and applications, it will be discussed herein with a particular emphasis on a medical or hospital environment, where a surgeon or health care practitioner performs. For example, one embodiment of the present design is in or with a phacoemulsification surgical system that comprises an independent graphical user interface (GUI) host module, an instrument host module, a GUI device, a ocular identification module, an ocular reader device, and a controller module, such as a foot switch, to control the surgical system.

It is to be understood that any type of system or software application configured to load user preferences based on the user's identity may benefit from the design presented herein, and such a design is not limited to a phacoemulsification system or even a medical system.

The present design may be implemented in, for example, systems including but not limited to phacoemulsification-vitrectomy systems, vitrectomy systems, dental systems, heart-lung surgical devices, industrial applications, communication network systems, access control systems, fire control/guidance devices, and aerospace applications.

The present design may employ various interface mechanisms to gain access to user profiles and programs to control the medical instrument, such as via an ocular reader device, or other subsystem, it will be discussed herein with a particular emphasis on authenticating users and providing authorization to access individual profiles stored in the medical instruments database via iris signature comparison, i.e. pattern recognition technique. The user interface device may include but is not limited to a touch screen monitor, iris imaging device, mouse, keypad, foot pedal switch, and/or a computer monitor. The present design is intended to provide a secure, reliable and efficient authentication and authorization user access or interface mechanism for accessing profiles and ultimately to load and execute programs containing a large number of configuration parameter values stored in a database file system that affect the behavior of the surgical instrument.

Although iris recognition is discussed with respect to embodiments of the present design, other biometric technologies such as fingerprint or speech recognition may provide satisfactory results in certain environments, e.g. industrial applications, communication network systems, and aerospace applications.

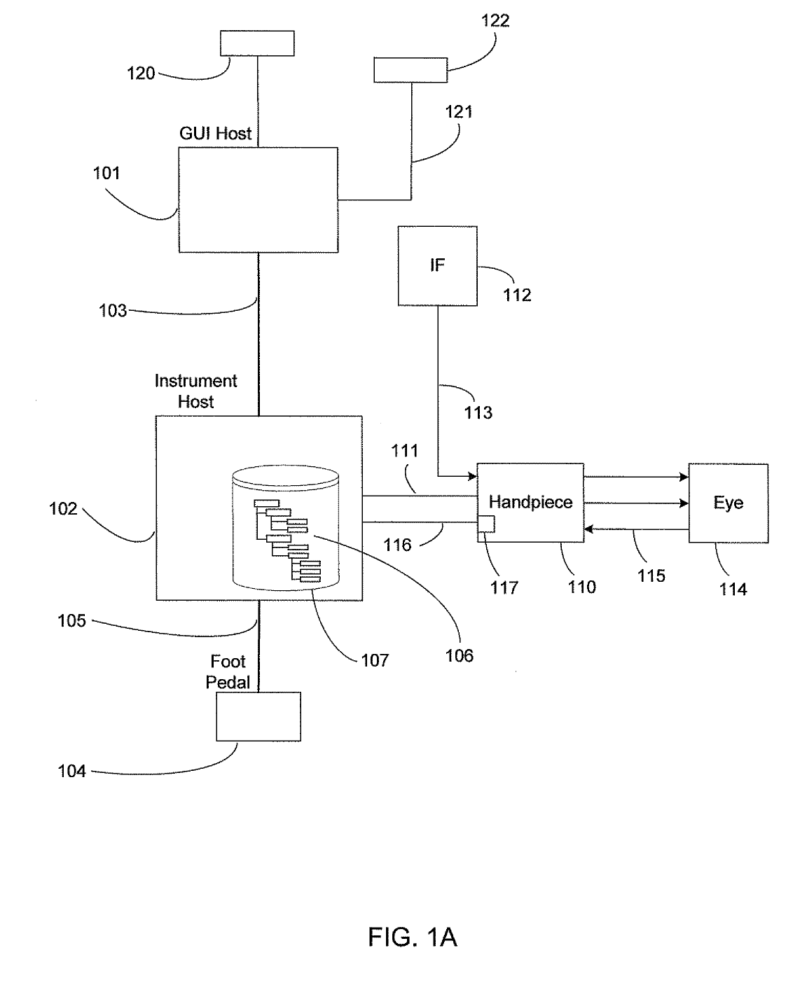

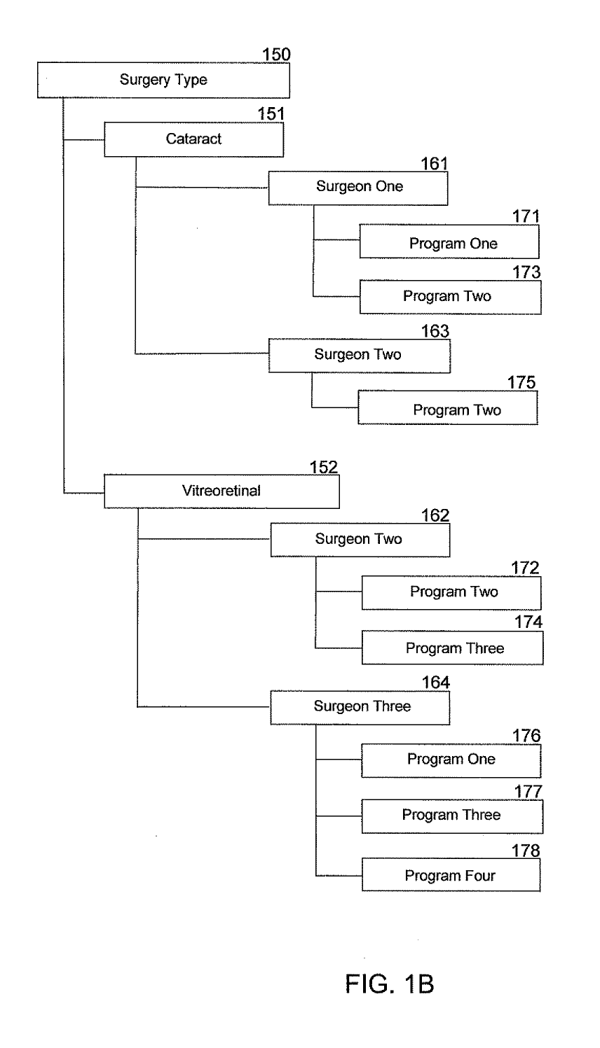

FIG. 1A illustrates an exemplary phacoemulsification/vitrectomy system in a functional block diagram to show the components and interfaces for a safety critical medical instrument system that may be employed in accordance with an aspect of the present invention. A serial or network communication cable 103 connects GUI host 101 module and instrument host 102 module for the purposes of controlling the surgical instrument host 102 by the GUI host 101. Instrument host 102 may be considered a computational device in the arrangement shown, but other arrangements are possible. A GUI device 120 is connected to GUI host 101 module for displaying information and to provide a mechanism for operator/user input. Although shown connected to the GUI host 101 module, GUI device 120 may be connected or realized on any other subsystem (not shown) that could accommodate such a display/input interaction device. A biometric capture device such as an iris recognition module 122 may be provided within or exterior to the GUI host 101, or in general associated with the GUI host, and may connect to GUI host 101 module via a communications cable 121 to provide a mechanism to acquire a user's signature, i.e. high-resolution imaging of the irises of an individual's eye(s) or iris scan, and authenticate a user's identity by comparing his own submitted signature, sometime referred to as a ‘template,’ to signatures acquired during enrollment and previously stored. Although shown connected to the GUI host 101 module, iris recognition module 122 may be connected or realized on any other subsystem (not shown) that could accommodate such a biometric input interaction device.

A foot pedal 104 switch module may transmit control signals relating internal physical and virtual switch position information as input to the instrument host 102 over serial communications cable or wireless via bluetooth 105. Instrument host 102 may provide a database file system 106 for storing configuration parameter values, programs, and other data saved in storage device 107. In addition, the database file system 106 may be realized on the GUI host 101 or any other subsystem (not shown) that could accommodate such a file system.

The phacoemulsification/vitrectomy system has a handpiece 110 that includes a needle and electrical means, typically a piezoelectric crystal, for ultrasonically vibrating the needle. The instrument host 102 supplies power on line 111 to a phacoemulsification/vitrectomy handpiece 110. An irrigation fluid source 112 can be fluidly coupled to handpiece 110 through line 113. The irrigation fluid and ultrasonic power are applied by handpiece 110 to a patient's eye, or affected area or region, indicated diagrammatically by block 114. Alternatively, the irrigation source may be routed to the eye 114 through a separate pathway independent of the handpiece. Aspiration is provided to eye 114 by the instrument host 102 pump (not shown), such as a peristaltic pump, through lines 115 and 116. A switch 117 disposed on the handpiece 110 may be utilized to enable a surgeon/operator to select an amplitude of electrical pulses to the handpiece via the instrument host and GUI host. Any suitable input device, such as for example, a foot pedal 104 switch may be utilized in lieu of the switch 117.

### Ocular Identification

The present design may involve an authentication and authorization utility for user identification via iris recognition. The present design may involve pre-populating an authentication database by capturing and storing each user's iris, i.e. images of the irises, as a biometric signature. Methods for capturing, maintaining, storing, and comparing user's biometric signature information, including iris recognition are generally understood by those skilled in the art.

The present design may be configured for collecting a user's biometric signature as input, and comparing this signature to previously stored signatures maintained in an authentication database. In the situation where the biometric signature or iris scan input into the utility is found to match a previously saved signature acquired during enrollment and stored in the authentication database, the utility may identify the user based on the matching signatures, and may provide communicate to the medical instrument system load and execute a program stored within the identified users profile.

In the situation where the signature provided by a user desiring system access does not match any enrollment signature stored in the authentication database, the utility may prevent or deny access to all profiles and may prevent the loading of any program stored within the profiles. In addition, the present designs apparatus and method may enable a system administrator maintain the authentication database including but not limited to operations such as add, modify and save a user's signature, delete or suspend a user, and alter authentication configuration parameters as needed. The authentication database file system structure may provide a means for maintaining and storing user's biometric signatures, available for use by the utility to identify the user and authorize the execution of a program saved either within or in association with his profile to control the behavior of the medical instrument. The iris recognition user identification apparatus and method of the present design for authenticating and authorizing access to profiles will now be described within a safety critical medical instrument system.

Referring to FIG. 1A, the medical instrument database file system 106 may store user profiles and associated programs is illustrated as residing within the instrument host 102 module, however the medical instrument database file system 106 may reside within the GUI host 101 module, other subsystems, or realized using external devices and/or software.

FIG. 1B is a block diagram illustrating an exemplary database file system 106 employing a hierarchical tree structure arranged in multiple levels of organization configured to store and recall user profiles and associated programs in accordance with the present design. FIG. 1B illustrates a three-level of organization database file system 106 layout for storing data and programs.

The surgical instrument system database structure illustrated in FIG. 1B may organize and store the instrument system configuration parameter values and programs in database file system 106. The top organizational level may involve surgery type at 150 and 152, where the second organizational level may involve surgeon name at 161, 162, 163, and 164. The third organizational level may involve program name at 171, 172, 173, 174, 175, 176, 177 and 178. FIG. 1B illustrates an example of the present design database file system 106 configured to store two surgery types, Cataract at 151 and Vitreoretinal at 152. The database example in FIG. 1B illustrates the database arranged to support surgeon one at 161 able to select either program one at 171 or program two at 173 from the set of stored programs for use in performing a cataract surgery.

Alternatively, the database example in FIG. 1B illustrates the database arranged to support surgeon two at point 162 able to select program two at point 172 from the set of stored programs for use in performing a cataract surgery. In addition, FIG. 1B illustrates the database arranged to support surgeon two at point 162 able to select either program two at point 172, or program three at point 174 from the set of stored programs for use in performing a Vitreoretinal surgery. Alternatively, the database example in FIG. 1B illustrates the database arranged to support surgeon three at point 164 able to select program one at 176, program three at point 177, or program four at point 178 from the set of stored programs for use in performing a Vitreoretinal surgery.

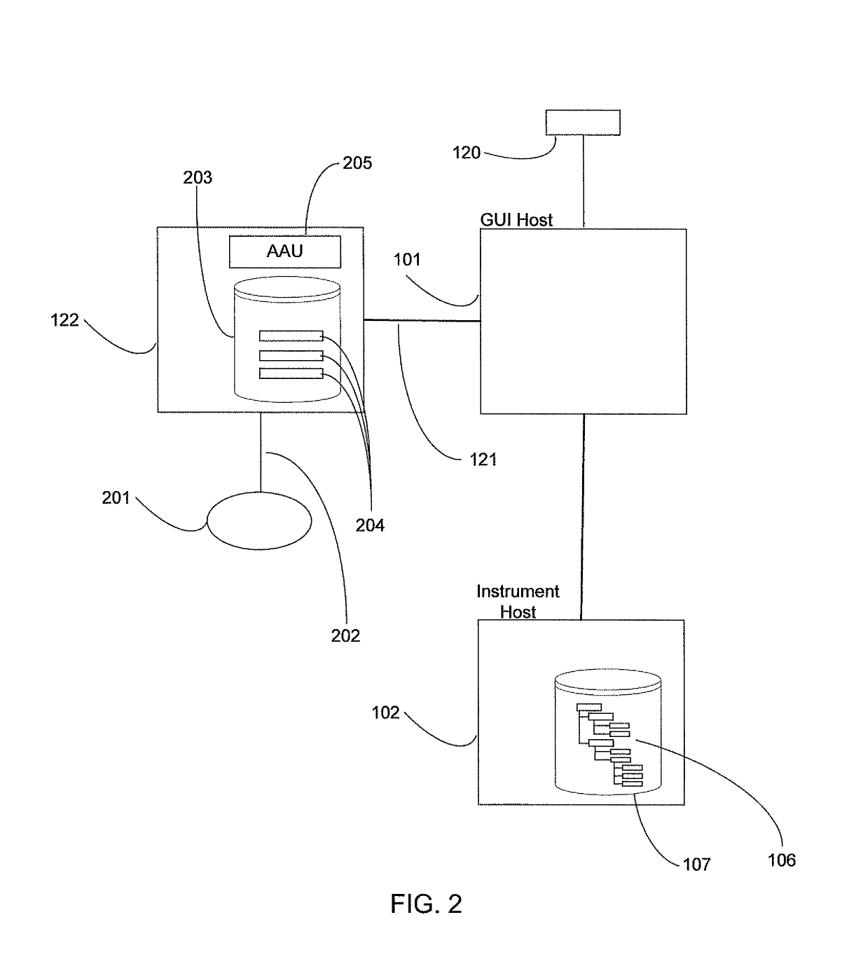

FIG. 2 is a block diagram illustrating the iris recognition and identification apparatus and method wherein an iris imaging device 201 and iris recognition module 122 supporting an authentication database 203 are connected via communications cable 202. In this arrangement, the present design is configured to identify a user and afford access to his profile and programs stored within database file system 106. Prior to accessing programs and operating instrument host 102, a user may convey her identity to the system by position her eye such that she can look into iris imaging device 201 for purposes of authentication. When the eye is properly positioned, the present design iris imaging device 201 may capture or collect a scan of the user's irises. Iris imaging device 201 may send the submitted signature via communications cable 202 to iris recognition module 122.

Iris recognition module 122 may compare the submitted signature received from iris imaging device 201 to one or more enrollment signatures 204 stored in the present design's authentication database 203. The comparison mechanism may continue to search or query authentication database 203 until an enrollment signature 204 is found to match the submitted signature. In the situation where the iris recognition module 122 matches a submitted signature with a stored enrollment signature, the iris recognition module 122 may authenticate user identity. At this point, the iris recognition module 122 may signal instrument host 102 to search or query database file system 106 to locate the identified users profile and may provide authorization to the instrument host 102 to load and execute programs found associated with the identified user profile. In this arrangement, the surgeon may simply look into iris imaging device 201 and the iris recognition module 122 will identify the surgeon and load their programs, preferences and settings enabling the user to control the medical instrument system and perform the scheduled procedure.

The comparison mechanism may continue to search or query authentication database 203 until it traverses the entire authentication database 203. If the present design examines and compares all enrollment signatures 204 stored in authentication database 203 to the submitted signature and no matching signature is not found, the present design may stop the comparison mechanism and indicate or signal to the user desiring access, e.g. via GUI device 120, that the present design was unable to identify the user. In this situation iris recognition module 122 may not need to communicate with instrument host and the instrument host 102 may remain in its current or quiescent state.

The iris recognition module 122 illustrated in FIG. 2 may operate separate from instrument host 102 or may be configured to operate as part of instrument host 102 or any other subsystem, e.g. GUI host 101. Although FIG. 2 illustrates the iris recognition module 122 as multiple separate entities, i.e. modules, process, and mechanism, the present design is not limited to a fixed number of separate entities and may be realized by incorporating some or all of the functionality of the present design into a single software entity. In addition, the present design may be realized by embedding the software utility into an existing medical instrument system design.

### Authentication and Authorization Utility

The ocular identification system apparatus and method may use an authentication and authorization utility (AAU) 205 realized within the iris recognition module 122 to efficiently enable surgeons and other medical professionals to access medical system instrument programs stored in a medical instrument system database, such as database file system 106. The AAU 205 may involve iris recognition and may image the medical instrument operator's iris to acquire a signature for use in determining his identity.

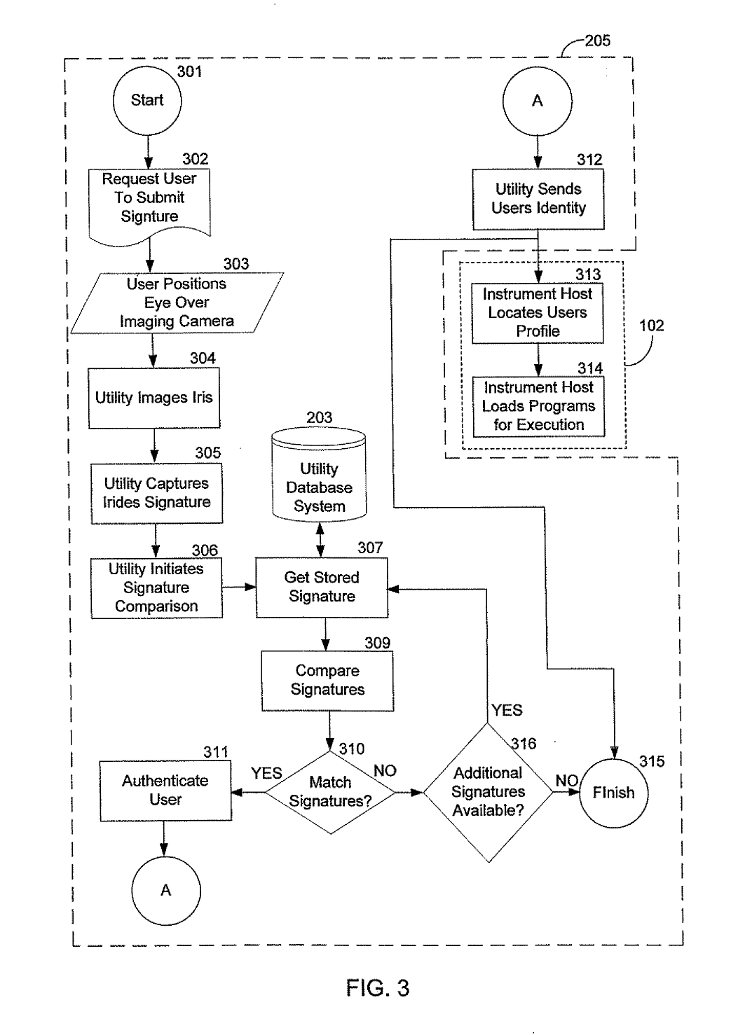

FIG. 3 is a flow chart illustrating an authentication and authorization utility 205 for accessing programs stored within a medical instrument system in accordance with an aspect of the present invention. FIG. 3 illustrates one example of operation of the AAU 205 and may employ an iris imaging device 201 for interaction with such a utility. This particular embodiment may allow the user to access her desired surgical program quickly. Accessing a program may involve loading and executing the program on instrument host 102 for purposes of controlling and tailoring the medical instrument's behavior while conducting the medical procedure.

In this configuration, the surgeon may start the AAU 205 at point 301. The AAU 205 may present a request at 302 to the user desiring to operate the medical instrument system to submit their signature. Based on this request, the user may position their eye over the iris imaging device 201 at 303 sufficient for imaging. The AAU 205 may scan and acquire the users iris signature at 304 and upon successful signature capture at 305 the AAU 205 may initiate a signature comparison mechanism at 306 in order to authenticate the identify of the user submitting their signature. The signature comparison mechanism may search or query the authentication database 203 to get a stored signature at 307. The AAU 205 comparison mechanism may compare the submitted signature to the enrollment signature 204 at 309 to determine if there is a match. If the signatures match at 310, the AAU 205 may authenticate the user's identity at 311.

Upon successful authentication, the AAU 205 may send the users identity at 312 to the instrument host 102 and may provide authorization to the instrument host 102 to load and execute the identified users programs. Instrument host 102 may locate the users profile in the database file system 106 based on the users authenticated identity at 313. Instrument host 102 may load the identified and authenticated users programs from database file system 106 into the medical instrument system for execution at 314. In this example, at point 315 the AAU 205 finishes, having successfully authenticated the users identity and authorized instrument host 102 to load their programs from their user profile.

If the submitted signature does not match the enrollment signature 204 retrieved from authentication database 203 at point 310, the AAU 205 may check the authentication database 203 to determine of additional signatures are available for comparison at 316. If additional signatures are found available for comparison matching, the present design's signature comparison mechanism may search or query the authentication database 203 to get the next stored enrollment signature 204 at point 307. The AAU 205 comparison mechanism may compare the submitted signature to the next stored enrollment signature 204 at 309 to determine if they match. If the signatures do not match at 310, the AAU 205 may continue to compare stored enrollment signatures 204 to the submitted signature until either a match is found at 310, or until AAU 205 has traversed the entire authentication database 203 and all stored enrollment signatures 204 have been considered at 316. In this example, at point 315 the AAU 205 finishes, unable to authenticate the user's identity.

As may be appreciated from FIGS. 2 and 3, the present design's authentication database 203 structure in combination with the authentication and authorization utility may allow the present design to quickly authenticate a users identity and provide authorization to the instrument host to load and execute the program desired for use in an upcoming procedure by efficiently sorting through the entire set of enrollment signatures 204.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for authenticating a user of a medical device, comprising:
storing ocular signatures in a database for at least one user permitted to access the medical device;
comparing said stored ocular signatures to an individual ocular signature associated with an individual desiring to employ the medical device; and
enabling the user to employ selected functionality of the medical device when at least one stored ocular signature substantially matches the individual ocular signature.

2. The method of claim 1, wherein the medical device comprises a medical component associated with a computing device.

3. The method of claim 2, wherein the user being enabled to employ selected functionality of the medical device causes at least one stored program to be made available within the computing device for use in association with the medical component.

4. The method of claim 2, wherein the user being enabled to employ selected functionality of the medical device causes a profile associated with the user to be made available within the computing device for use in association with the medical component.

5. The method of claim 1, wherein the comparing comprises evaluating the ocular profile of the user using a biometric device to determine the individual ocular signature.

6. The method of claim 1, wherein the selected functionality comprises settings desired by the user.

7. The method of claim 2, wherein ocular signatures are stored on the computing device, and the comparing occurs on the computing device.

8. The method of claim 1, wherein the medical device comprises a phacoemulsification device.

9. A method for authenticating a user desiring employing a medical device, comprising:
acquiring a representation of at least a portion of the user's eye, the representation being made available as an ocular signature;
authenticating the user by comparing the ocular signature with a database comprising at least one previously obtained ocular reference signature; and
enabling the medical device to operate in accordance with a profile associated with the user when the authenticating indicates the ocular signature is substantially similar to at least one previously obtained ocular reference signature.

10. The method of claim 9, wherein the medical device comprises a medical component associated with a computing device.

11. The method of claim 9, wherein the medical device being enabled to operate in accordance with a profile associated with the user causes at least one stored program to be made available within the computing device for use in association with the medical component.

12. The method of claim 9, wherein the acquiring further comprises evaluating the ocular profile of the user using a biometric device to determine the ocular signature.

13. The method of claim 9, wherein the selected functionality comprises medical device settings desired by the user.

14. The method of claim 10, wherein at least one previously obtained ocular reference signature is stored on the computing device, and the authenticating occurs on the computing device.

15. The method of claim 9, wherein the medical device comprises a phacoemulsification device.

16. A medical system comprising:
a medical component; and
a computing device associated with the medical component, the computing device comprising:
a database configured to receive and maintain at least one permitted user ocular signature; and
a computational utility configured to receive an ocular signature of a user and compare the ocular signature of the user to at least one permitted user ocular signature maintained in the database;
wherein upon the computational utility determining that the ocular signature of the user substantially matches at least one permitted user ocular signature, the user is authorized to employ selected functionality of the medical device.

17. The medical system of claim 16, further comprising a user interface device configured to obtain the ocular signature of the user and provide the ocular signature to the computational utility.

18. The medical system of claim 16, wherein the database comprises associations between medical computer programs and specific users.

19. The medical system of claim 17, wherein the user interface device employs a biometric device to determine the ocular signature.

20. The medical system of claim 16, wherein the selected functionality comprises medical device settings desired by the user.

21. The method of claim 9, wherein the medical device comprises a phacoemulsification device.
